(19) United States
(12) Patent Application Publication
(10) Pub. No.: US 2003/0053305 A1
(43) Pub. Date: Mar. 20, 2003

(54) Torch simulating device

(76) Inventor: Yu Chuan Lin, Chong Ho City (TW)

Correspondence Address: Yu Chuan LIN, P.O. Box 10-69, Chong Ho, TW

(21) Appl. No.: 09/954,400

(22) Filed: Sep. 14, 2001

(51) Int. Cl. F21L 4/00; F21V 33/00

(52) U.S. Cl. 362/96; 362/208; 362/392; 362/810

(57) ABSTRACT

A torch simulating device includes a housing having a chamber for receiving a fan devices and a flame-like member disposed on the housing and located above the fan device for being fluctuated by the fan device. One or more batteries may be used for energizing the fan device to fluctuate the flame-like member to simulate the torch. A handle may be secured to the housing for receiving the batteries. No gasoline will be burned or ignited, such that no poisonous gases will be generated, and neither disasters nor damages will be generated by the flame-like member.

### BACKGROUND OF THE INVENTION

1. Field of the Invention

The present invention relates to a torch, and more particularly to a torch simulating device.

2. Description of the Prior Art

Typical torches comprise a handle including a chamber formed or provided on top or in the upper portion thereof for receiving spongy materials and gasoline or the like. The gasoline should be ignited before the torch may be used. However, poisonous gases may be generated when the gasoline is ignited, and may pollute our environment. In addition, the torch may cause disasters and damages inadvertently.

The present invention has arisen to mitigate and/or obviate the afore-described disadvantages of the conventional torches.

### SUMMARY OF THE INVENTION

The primary objective of the present invention is to provide a torch simulating device including a flame like device without igniting or burning gasoline, and without generating poisonous gases, and without causing disasters and damages.

In accordance with one aspect of the invention, there is provided a torch simulating device for simulating a torch, the torch simulating device comprising a housing including a chamber formed therein, a fan device received in the housing for generating an air, a flame-like member disposed on the housing and located above the fan device, for being actuated and fluctuated by the fan device, and means for energizing the fan device to actuate and fluctuate the flame-like member to simulate the torch. No gasoline will be burned or ignited, such that no poisonous gases will be generated, and neither disasters nor damages will be generated by the flame-like member.

The energizing means includes a motor coupled to the fan device for actuating the fan device. The housing includes a seat disposed in the chamber of the housing, for supporting the fan device. The seat includes at least one channel formed therein for air circulating purposes.

The seat includes at least one bar laterally extended therefrom for engaging with the housing and for positioning the seat in the housing. The housing includes an outer peripheral portion having at least one slit formed therein for air circulating purposes.

A board is further provided and disposed on top of the housing for supporting the flame-like member. The board includes a plurality of orifices formed therein and located below the flame-like member.

The board includes at least one adhesive member provided thereon, the flame-like member includes at least one extension extended therefrom and engaged with the adhesive member, for being secured to the board.

The energizing means includes a handle secured to the housing, and at least one battery received in the handle and electrically coupled to the fan device, for energizing the fan device.

The housing includes a bottom portion having a first conductor provided thereon and electrically coupled to the fan device, the battery includes a center electrode coupled to the first conductor and includes a case electrode, and a second conductor having a first end coupled to the case electrode of the battery and having a second end for selectively coupling to the first conductor.

A switch is further coupled and provided between the second conductor and the first conductor for selectively actuating and coupling the second end of the second conductor to the first conductor.

A device is further provided for lighting the flame-like member, and includes at least one light device directed toward the flame-like member.

The energizing means includes a handle secured to the housing, and at least one battery received in the handle and electrically coupled to the light device, for energizing the light device.

The energizing means includes a circuit board electrically coupled between the light device and the battery.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a torch simulating device in accordance with the present invention;

FIG. 2 is an exploded view of the torch simulating device;

FIG. 3 is a cross sectional view taken along lines 3-3 of FIG. 1;

FIG. 4 is a cross sectional view similar to FIG. 3, illustrating the operation of the torch simulating device; and

FIGS. 5 and 6 are partial perspective views illustrating the operation of the torch simulating device.

### DETAILED DESCRIPTION OF THE PREFERRED EMBODIMENT

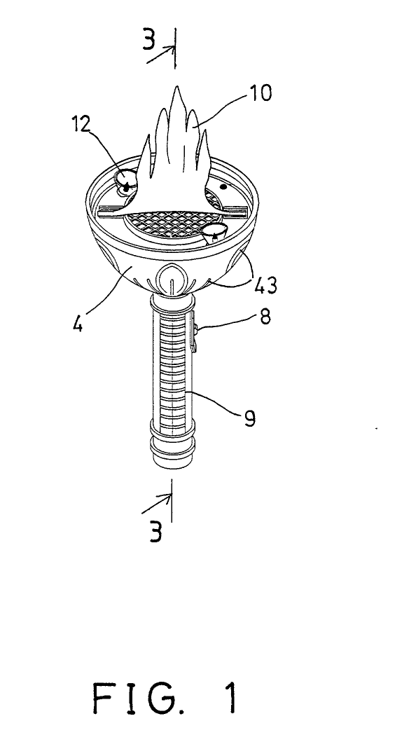

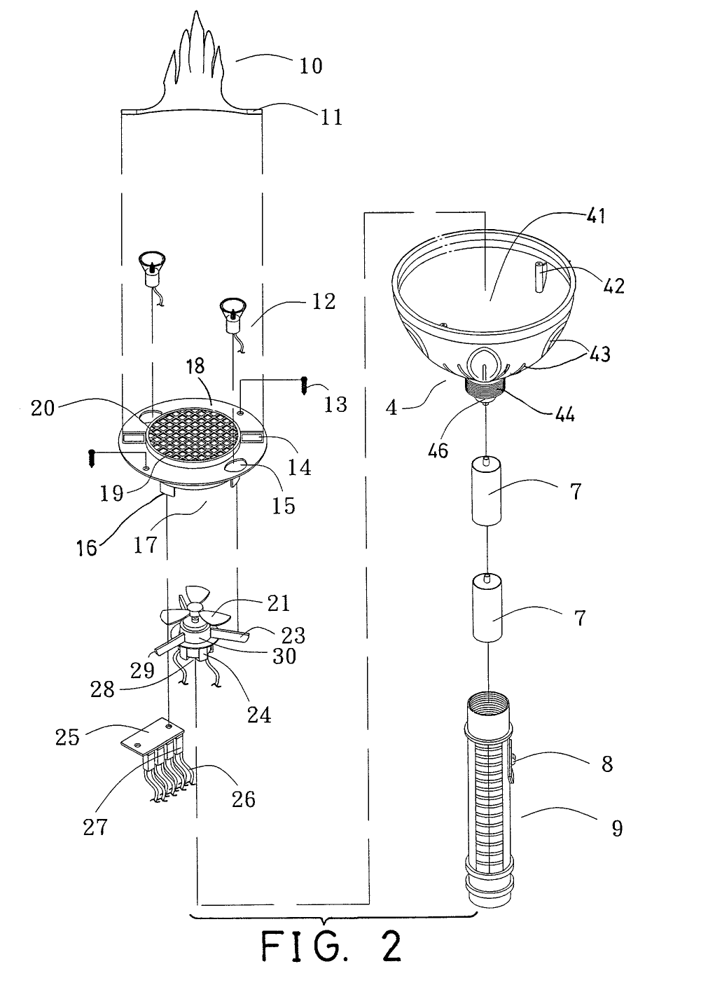

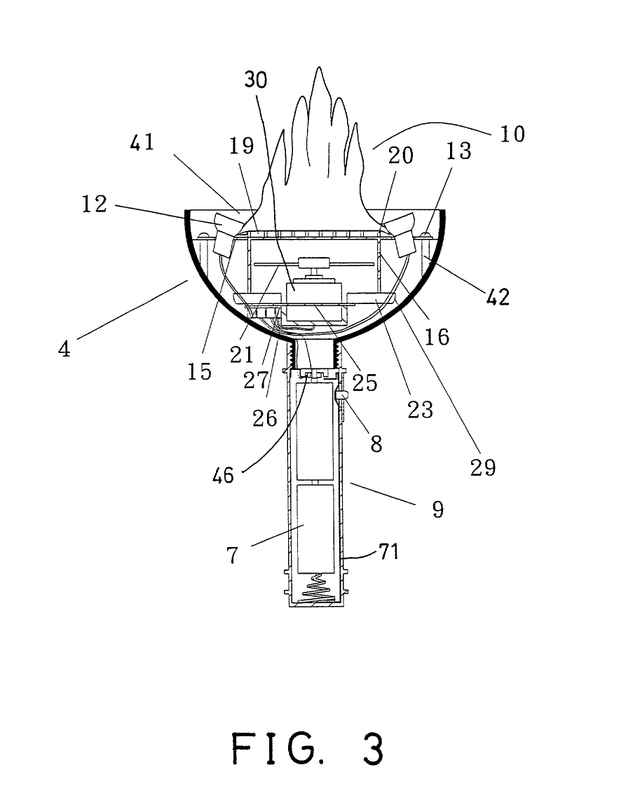

Referring to the drawings, and initially to FIGS. 1-3, a torch simulating device in accordance with the present invention comprises a bowl-shaped housing 4 including an open top and including a lower peripheral portion having one or more gaps or slits 43 formed therein for air circulating purposes and/or for heat dissipating purposes. The housing 4 includes a chamber 41 formed or provided therein for receiving the other elements or members, and includes one or more studs 42 provided therein, and preferably disposed in the inner peripheral portion thereof. The housing 4 further includes a threaded portion 44 formed or provided in the bottom portion thereof, and a conductor 46 disposed or attached to the bottom of the housing 4, such as attached to the bottom of the threaded portion 44 of the housing 4.

A seat 24 is disposed in the lower or bottom portion of the chamber 41 of the housing 4, and includes one or more bars 23 laterally extended outward therefrom. The bars 23 each includes a curved outer end 29 having a curvature corresponding to the curvature of the inner peripheral portion of the housing 4 for stably engaging with and positioning to the housing 4. The seat 24 may further be solidly secured to the housing 4 with fasteners, adhesive materials or the like. The seat 24 includes a lower peripheral portion having one or more channels 28 formed therein for air circulating purposes and/or for heat dissipating purposes. A motor 30 is disposed or secured on the seat 24, and a fan device 21 is attached to the motor 30 and rotated or driven by the motor 30.

A circuit board 25 is disposed in the chamber 41 of the housing 4 and secured to the seat 24 or the bars 23 with fasteners, adhesive materials or the like. One or more electric wires 26 include one end electrically coupled to the conductor 46 of the housing 4 and the other end 27 electrically coupled to the circuit board 25. A barrel or a handle 9 is threaded or secured to the threaded portion 44 of the housing 4, or secured to the bottom of the housing 4 with the other fasteners or latches or the like. One or more batteries 7 are received in the handle 9 and include a center electrode electrically coupled to the conductor 46. Another conductor 71 has one end electrically coupled to the case electrode of the batteries 7, for example, and the other end selectively coupled to the conductor 46 with a switch 8. The switch 8 may be depressed or actuated or moved relative to the handle 9 for selectively coupling the other end of the conductor 71 to the conductor 46, and for selectively energizing the motor 30 and thus the fan device 21.

A board 17 is secured in the upper portion of the housing 4 and secured to the studs 42 of the housing 4 with such as the fasteners 13. The board 17 includes one or more legs 16 extended downward therefrom for engaging with the seat 24, or for engaging with the bars 23, for further solidly securing the seat 24 and the motor 30 within the housing 4. The board 17 includes one or more openings 15 formed in the peripheral portion thereof for receiving light bulbs or the other light devices 12, and includes a number of orifices 19 formed in the middle portion thereof, and formed or defined by such as a screen 20. The light devices 12 are electrically coupled to the circuit board 25, and may be, for example, controlled or actuated by the switch 8.

One or more, such as two opposite adhesive tapes or members 14 are provided and disposed on the upper surface 18 of the board 17. A flexible flame-like member 10 is preferably made of plastic or film or membrane materials, and includes two extensions 11 extended or provided in the lower portion thereof for securing to the board 17 with the adhesive materials 14, for example. The flame-like member 10 is disposed or provided above the orifices 19 or the screen 20 of the board 17. The light devices 12 are directed toward the flame-like member 10 for lighting the flame-like member 10.

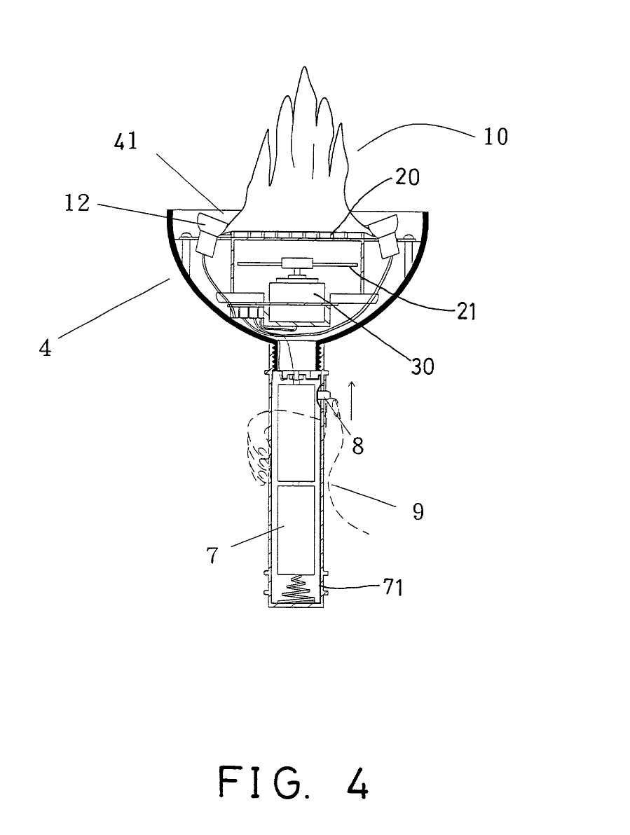

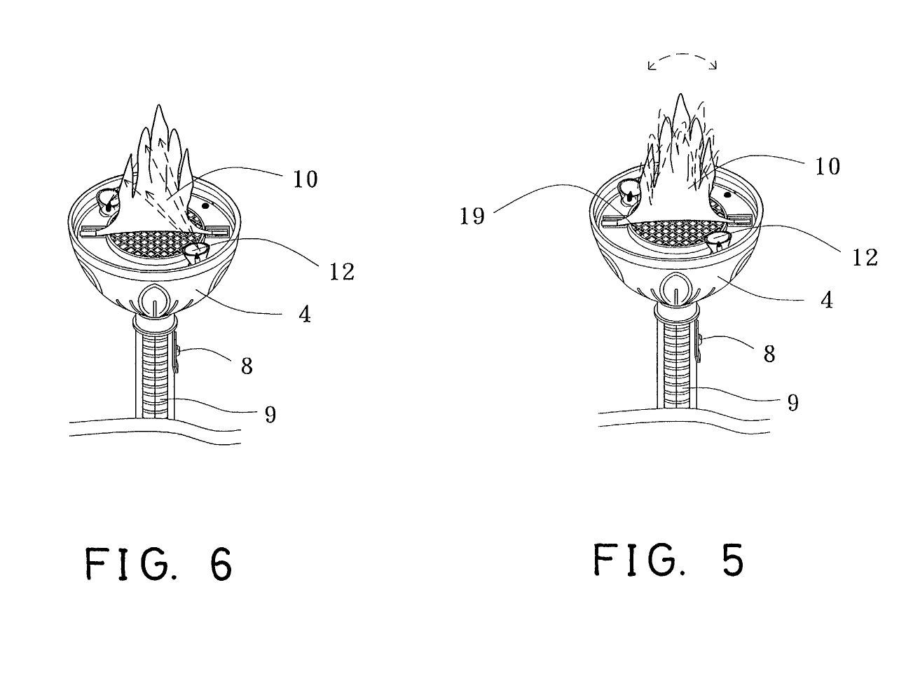

In operation, as shown in FIGS. 4 and 5, the fan device 21 and the motor 30 may be energized or controlled by the switch 8, in order to generate an air to flow upward through the orifices 19 of the screen 20, and to fluctuate or to oscillate the flame-like member 10, in order to simulate a torch. The flame-like member 10 is preferably painted or provided with red and/or orange color for simulating the flame. As shown in FIG. 6, the light device 12 may further be or may be selectively actuated or energized to light the flame-like member 10, by such as the switch 8, and to increase the simulation of the flame-like member 10.

Accordingly, the torch simulating device in accordance with the present invention includes a flame like device or member that may be used for simulating the flame without igniting or burning gasoline, and without generating poisonous gases, and without causing disasters and damages.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A torch simulating device for simulating a torch, said torch simulating device comprising:
a housing including a chamber formed therein,
a fan device received in said housing for generating an air,
a flame-like member disposed on said housing and located above said fan device, for being actuated and fluctuated by said fan device, and
means for energizing said fan device to actuate and fluctuate said flame-like member to simulate the torch.

2. The torch simulating device according to claim 1, wherein said energizing means includes a motor coupled to said fan device for actuating said fan device.

3. The torch simulating device according to claim 1, wherein said housing includes a seat disposed in said chamber of said housing, for supporting said fan device.

4. The torch simulating device according to claim 3, wherein said seat includes at least one channel formed therein for air circulating purposes.

5. The torch simulating device according to claim 3, wherein said seat includes at least one bar laterally extended therefrom for engaging with said housing and for positioning said seat in said housing.

6. The torch simulating device according to claim 1, wherein said housing includes an outer peripheral portion having at least one slit formed therein for air circulating purposes.

7. The torch simulating device according to claim 1 further comprising a board disposed on top of said housing for supporting said flame-like member.

8. The torch simulating device according to claim 7, wherein said board includes a plurality of orifices formed therein and located below said flame-like member.

9. The torch simulating device according to claim 7, wherein said board includes at least one adhesive member provided thereon, said flame-like member includes at least one extension extended therefrom and engaged with said adhesive member, for being secured to said board.

10. The torch simulating device according to claim 1, wherein said energizing means includes a handle secured to said housing, and at least one battery received in said handle and electrically coupled to said fan device, for energizing said fan device.

11. The torch simulating device according to claim 10, wherein said housing includes a bottom portion having a first conductor provided thereon and electrically coupled to said fan device, said at least one battery includes a center electrode coupled to said first conductor and includes a case electrode, and a second conductor having a first end coupled to said case electrode of said at least one battery and having a second end for selectively coupling to said first conductor.

12. The torch simulating device according to claim 11 further comprising a switch coupled and provided between said second conductor and said first conductor for selectively actuating and coupling said second end of said second conductor to said first conductor.

13. The torch simulating device according to claim 1 further comprising means for lighting said flame-like member.

14. The torch simulating device according to claim 13, wherein said lighting means includes at least one light device directed toward said flame-like member.

15. The torch simulating device according to claim 14, wherein said energizing means includes a handle secured to said housing, and at least one battery received in said handle and electrically coupled to said at least one light device, for energizing said at least one light device.

16. The torch simulating device according to claim 25, wherein said energizing means includes a circuit board electrically coupled between said at least one light device and said at least one battery.
